(19) United States
(12) Patent Application Publication
(10) Pub. No.: US 2009/0189305 A1
(43) Pub. Date: Jul. 30, 2009

(54) METHOD OF MAKING FLEXIBLE FOAMING MEMBER FROM RECYCLED MATERIALS

(76) Inventor: Semi KAO, Huatan Township (TW)

Correspondence Address: SINORICA, LLC, 2275 Research Blvd., Suite 500, ROCKVILLE, MD, 20850, US

(21) Appl. No.: 12/048,523

(22) Filed: Mar. 14, 2008

(30) Foreign Application Priority Data
Jan. 24, 2008 (TW) 97102732

(51) Int. Cl. B29C 44/04

(52) U.S. Cl. 264/45.4

(57) ABSTRACT

The present invention provides a method of making a flexible foaming member from recycled material. The first step is recycling wastes including rubber, plastic, fiber, and metal, and then crushing the wastes into pieces. Next, the pieces are separated according to specific weights of each of the pieces into a plurality of groups, and then choose predetermined groups of the pieces in a predetermined ration, and mixing the pieces with a flexible material and a foaming agent to form a mixture. The last step is pressing the mixture into a plate-like foaming material, and vulcanizing the foaming material to form a flexible foaming member. The chosen groups of the pieces and the ratio thereof may make a flexible foaming member with specific property.

### BACKGROUND OF THE INVENTION

1. Field of the Invention

The present invention relates generally to a flexible pad, and more particularly to a method of making a flexible foaming member from a recycled material.

2. Description of the Related Art

For limited natural resource of earth, there are recycling equipments in every place, such as home, school, office and other places. The recycled wastes may be remade into many products, for example, papers, fuel and the like.

Typically, the recycled materials with single material, such as PET bottles, glass products, plastics, metal products and papers, are easy to recycle than composite materials. To recycle composite material, it needs various processes to separate different material in the composite material, and then pick up specific materials for recycling. In the processes of separation of composite material, many agents and solutions are added, especially for recycling expensive materials, so that more pollution and hazard materials are produced after these processes. To separate the composite material with metal and nonmetal, the preliminary separating process usually uses the different properties, such as magnet or concentration, of metal and nonmetal. After the preliminary separating process, however, labors are the main in the following processes. It wastes time and doesn't meet the economy need.

The conventional flexible foaming member, such as insole, Yoga pad, and the like, are made of foaming material, such as natural rubber. They waste natural resource and produce pollution in the fabrication processes.

### SUMMARY OF THE INVENTION

The primary objective of the present invention is to provide a method of making a flexible foaming member from a recycled material without above drawback. The method of the present invention doesn't need to separate the recycled material into single material. Foaming agent is added into the recycled material to be a raw material that the entire recycled material may be reused to reduce waste quantity and cost of recycling, and, furthermore, it may reduce the use of natural resource.

According to the objectives of the present invention, a method of making a flexible foaming member from recycled materials, comprising the steps of: recycling wastes including rubber, plastic, fiber, and metal; crushing the wastes into pieces; separating the pieces according to specific weights of each of the pieces into a plurality of groups; choosing predetermined groups of the pieces in a predetermined ration, and mixing the pieces with a flexible material and a foaming agent to form a mixture; pressing the mixture into a plate-like foaming material; and vulcanizing the foaming material to form a flexible foaming member.

### BRIEF DESCRIPTION OF THE DRAWINGS

FIG. 1 is a flow chart of a first preferred embodiment of the present invention;

FIG. 2 is a perspective view of the foaming member made by the method of the first preferred embodiment of the present invention; and

FIG. 3 is a flow chart of a second preferred embodiment of the present invention.

### DETAILED DESCRIPTION OF THE INVENTION

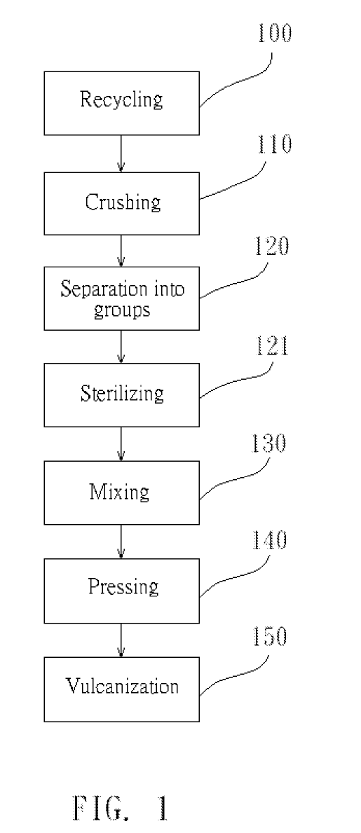

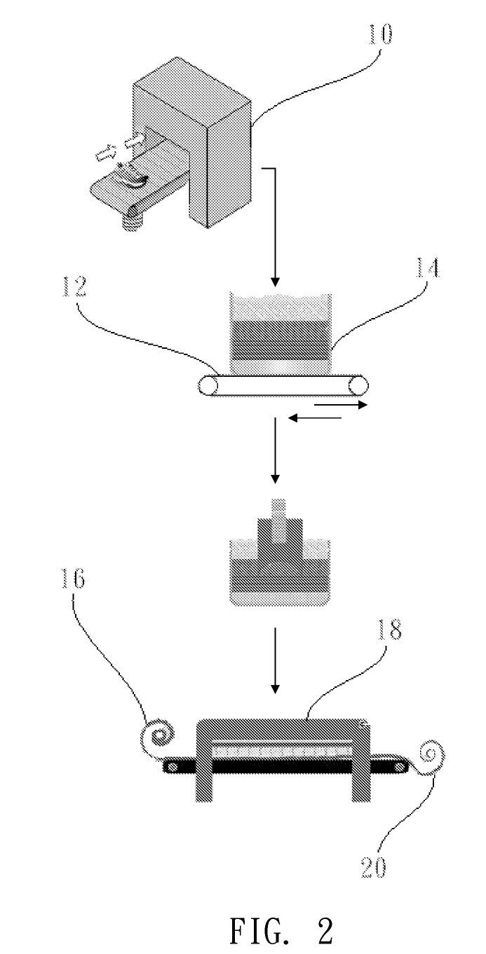

As shown in FIG. 1 and FIG. 2, a method of making a flexible foaming member from a recycled material of the first preferred embodiment of the present invention includes the following steps of:

The first step is recycling 100. Wastes having rubber, plastic, fiber, metal, and so on, such as shoes, are recycled.

The second step is crushing 110. A conventional crushing machine 10 is incorporated to crush the recycled wastes (the sports shoes) into pieces. There still are some pieces including two or more materials, but these pieces still may be used as a second-class raw material. The pieces mainly including rubber may be used as a flexible adjusting material of a foaming raw material; the pieces mainly including plastic may be used as a hardness adjusting material of the foaming raw material; the pieces mainly including fiber is used as a cross-linking agent or a reinforcing agent of the foaming raw material; and the pieces mainly including metal is used as a wear-proof and weight-adjusting material of the foaming raw material. Some recycled materials have grease that may be used as a softening agent without having to wash it away or separate.

The third step is separation into different groups 120. A container 14 is put on a conveying belt 12 of a conveying apparatus to receive the pieces of the crushed recycled material. When the conveying belt 12 is moving, it will vibrate the container 14 that causes the heavier pieces going down to the bottom, and the lighter pieces going up to the top, so that the pieces are separated into several groups according to their specific weights (or sorts). Of course, conventional separating methods, such as magnetic method, sieving method, and the other known methods, may be incorporated in the present invention to separate the pieces into a plurality of groups.

The fourth step of the present invention is mixing raw materials 130. The pieces of predetermined groups in a predetermined ratio are added into a flexible material and a foaming agent to form a mixture. To make a flexible foaming member for insole, exercise pad, or Yuga pad, the flexible material may be natural rubber (NR), polyurethane (PU), polyvinyl chloride (PVC), polyethylene (PE), styrene butadiene rubber (SBR), and the other relative flexible materials. The foaming agent may be an organic foaming agent. The chosen groups and ratio of the pieces of the recycled materials determine the property of the flexible foaming member, so we choose predetermined groups of the pieces, such as rubber, plastic, fiber, and metal in a predetermined ratio, to make the flexible foaming member with predetermined property

The fifth step of the present invention is pressing 140. A conventional pressing machine is incorporated to press the mixed raw material to a plate-like foaming material 16.

The last step of the present invention is vulcanization 150. A conventional vulcanization foaming box 18 is incorporated to vulcanize the foaming material 16 that a flexible foaming member 20 is formed.

To avoid the problem of germs in the pieces of the cycled materials, we further provides a sterilizing step 121 between the separation step 120 and the mixing step 130. The sterilizing step 121 is heating the pieces in a high temperature or adding a germicide in the pieces for sterilization.

The method of the present invention provides the pieces and the flexible materials bonded together by the gas pressure generated in the chemical reaction of foaming agent that no glue is involved in the processes. It doesn't have to separate the recycled material into single material in the present invention that most of the recycled material may be used in the present invention to cost down the recycling work.

The groups (sorts) and ratio of the components of the pieces of the recycled materials determine the property of the flexible foaming member. For example, if we want the flexible foaming member with greater elasticity, the ratio of rubber has to be raised. For the other components, plastic may raise the hardness, and metal may raise wear-proof and weight. Some recycled materials have grease that may be used as a softening agent without having to wash it away or separate, so the pieces with grease may be used as foaming materials and adjusting the property of the flexible foaming member.

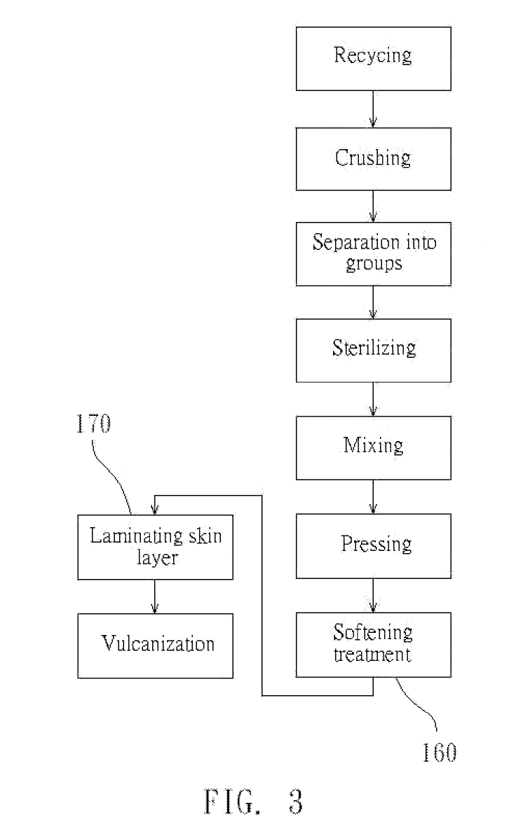

As shown in FIG. 3, the second embodiment of the present invention provides a method of making a multi-layer pad with different properties and hardnesses. Basically, the method of the second embodiment is similar to the first embodiment, and further has the following steps between the pressing step and the vulcanization step:

Softening treatment 160: it provides heat treatment on a surface of the foaming material to a range between 150° C. and 250° C., or coats surface softening agent on the surface of the foaming material to soften the surface of the foaming material.

Lamination of skin layer 170: it puts a skin layer on the softened surface of the foaming material and presses them together. The skin layer may be as same as the foaming material or different from, such as fabric or plastic film.

The foaming material with the skin layer is sent to a vulcanization foaming box for vulcanization. In vulcanization, it will bond the skin layer to the foaming material firmly by the gas pressure of reaction.

Many wastes including rubber, plastic, fiber and metal bonding together firmly, such as sports shoes, are hard to separate by automatic machine, and the only way of separation is by labors, so that the sports shoes are excluded from the recycled goods. With the method of the present invention, sports shoes may be totally recycled to make flexible foaming members. Of course, the recycled pieces mainly including fiber may be used as cross-linking agent of the foaming raw materials. Beside that, it also may reduce the quantity of cross-linking agent for conventional foaming material. In addition, plastic is used for adjusting the hardness, furthermore, it may be added in plastic flowerpot. The recycled pieces mainly including rubber may be added in rubber plate for vehicles or raw materials for PU runway.

In conclusion, the method of the present invention provides the recycled pieces and flexible materials bonding together by gas pressure of chemical reaction in vulcanization that no glue is involved in the present invention. The recycled materials used in the present invention don't need to separate into single materials that most parts of the recycled materials may be used in the present invention to reduce the waste quantity and cost down the recycling work.

The description above is a few preferred embodiments of the present invention and the equivalence of the present invention is still in the scope of the claim of the present invention.

What is claimed is:

1. A method of making a flexible foaming member from recycled materials, comprising the steps of:
recycling wastes including rubber, plastic, fiber, and metal;
crushing the wastes into pieces;
separating the pieces according to specific weights of each of the pieces into a plurality of groups;
choosing predetermined groups of the pieces in a predetermined ration, and mixing the pieces with a flexible material and a foaming agent to form a mixture;
pressing the mixture into a plate-like foaming material; and
vulcanizing the foaming material to form a flexible foaming member.

2. The method as defined in claim 1, further comprising the step of sterilizing the pieces after the step of separating the pieces.

3. The method as defined in claim 2, wherein the pieces is heated for sterilizing.

4. The method as defined in claim 3, further comprising the step of adding a germicide in the pieces.

5. The method as defined in claim 1, wherein a crushing machine is incorporated in crushing the wastes.

6. The method as defined in claim 1, wherein the pieces are vibrated to separate the pieces according to the specific weights automatically.

7. The method as defined in claim 6, wherein the pieces are put in a container, and the container is put on conveying belt of a conveying apparatus that the conveying belt will vibrate the pieces in the container when the conveying apparatus conveys the container, and the groups of the pieces are in different levels in the container.

8. The method as defined in claim 1, wherein the foaming agent is an organic foaming agent.

9. The method as defined in claim 1, wherein the flexible material includes natural rubber (NR), polyurethane (PU), polyvinyl chloride (PVC), polyethylene (PE), and styrene butadiene rubber (SBR).

10. The method as defined in claim 1, wherein a pressing machine is incorporated in pressing the mixture to the plate-like foaming material.

11. The method as defined in claim 1, wherein changing the ratio of the group of the pieces mainly including rubber changes an elasticity of the foaming material.

12. The method as defined in claim 1, wherein changing the ratio of the group of the pieces mainly including plastic changes a hardness of the foaming material.

13. The method as defined in claim 1, wherein the group of the pieces mainly including fiber is used as a cross-linking agent.

14. The method as defined in claim 1, wherein changing the ratio of the group of the pieces mainly including metal changes a wear-proof and a weight of the foaming material.

15. The method as defined in claim 1, further comprising the steps of between the step of pressing the mixture and the step of vulcanizing the foaming material:
softening a surface of the plate-like foaming material; and
laminating a skin layer on the surface of the foaming material.

16. The method as defined in claim 15, wherein the surface of the foaming material is heated to a temperature between 150° C. and 250° C. to soften the surface.

17. The method as defined in claim 15, wherein a softening agent is coated on the surface of the foaming material to soften the surface.

18. The method as defined in claim 15, wherein the skin layer and the foaming material are made of different materials.

19. The method as defined in claim 1, wherein the wastes are shoes.
